(19) United States
(12) Patent Application Publication
(10) Pub. No.: US 2022/0245295 A1
(43) Pub. Date: Aug. 4, 2022

(54) GENERATING A DYNAMIC PHOTOVOLTAIC SYSTEM DESIGN AND PROPOSAL

(71) Applicant: SunPower Corporation, San Jose, CA (US)

(72) Inventors: Jacob WACHMAN, San Jose, CA (US); Terrence BROWN, San Jose, CA (US); Aaron LAWRENCE, San Jose, CA (US); Bryan RICHARD, San Jose, CA (US); Deepesh MAKKAR, San Jose, CA (US)

(73) Assignee: SunPower Corporation, San Jose, CA (US)

(21) Appl. No.: 17/589,905

(22) Filed: Feb. 1, 2022

Related U.S. Application Data
(60) Provisional application No. 63/144,190, filed on Feb. 1, 2021.

(51) Int. Cl. G06F 30/18; G06F 30/12; G06F 30/13; G06Q 30/02

(52) U.S. Cl. CPC G06F 30/18; G06F 30/12; G06F 2113/04; G06Q 30/0283; G06F 30/13

(57) ABSTRACT

Generating a photovoltaic system design and proposal includes fetching a maximum solar panel design for a photovoltaic system design from a photovoltaic system design tool; fetching an electricity profile for the photovoltaic system design; receiving one or more modifications to one or more of the photovoltaic system design and an environment of the photovoltaic system; determining customer pricing based on one or more of the modified photovoltaic system design and the modified environment of the photovoltaic system; and generating a customer proposal based on the modified photovoltaic system design and the modified environment of the photovoltaic system.

### CROSS-REFERENCE TO RELATED APPLICATION

This application claims the benefit of U.S. Provisional Application No. 63/144,190, filed Feb. 1, 2021, which is incorporated herein by reference in its entirety.

### BACKGROUND

Conventionally, a solar panel system design is created with significant manual input, even when conventional design software is used, to accommodate regulatory restrictions, obstructions and production estimates. Further, solar panel system designs based on local site information and changes to those designs take manual intervention and time.

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

### SUMMARY

According to aspects of the disclosed subject matter, generating a photovoltaic system design and proposal includes fetching a maximum solar panel design for a photovoltaic system design from a photovoltaic system design tool; fetching an electricity profile for the photovoltaic system design; receiving one or more modifications to one or more of the photovoltaic system design and an environment of the photovoltaic system; determining customer pricing based on one or more of the modified photovoltaic system design and the modified environment of the photovoltaic system; and generating a customer proposal based on the modified photovoltaic system design and the modified environment of the photovoltaic system.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an exemplary system for photovoltaic (PV) system design according to one or more aspects of the disclosed subject matter;

FIG. 2 illustrates an exemplary user interface displayed via the remote device according to one or more aspects of the disclosed subject matter;

FIG. 3 illustrates an exemplary workflow for generating a customer proposal according to one or more aspects of the disclosed subject matter;

FIG. 4 illustrates an exemplary user interface for creating a construction-ready design according to one or more aspects of the disclosed subject matter;

FIG. 5 illustrates an exemplary user interface for creating a construction-ready design according to one or more aspects of the disclosed subject matter;

FIG. 6 illustrates an exemplary user interface for creating a construction-ready design according to one or more aspects of the disclosed subject matter;

FIG. 7 illustrates an exemplary workflow for modifying the PV system design and displaying real time updates to energy production based on panel movement according to one or more aspects of the disclosed subject matter;

FIG. 8 illustrates an exemplary user interface for modifying a built environment and displaying energy production corresponding to the built environment according to one or more aspects of the disclosed subject matter;

FIG. 9 illustrates a workflow for modifying a built environment and displaying energy production corresponding to the built environment according to one or more aspects of the disclosed subject matter; and

FIG. 10 is a block diagram of a computer that may implement the various embodiments described herein.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

Referring now to the drawings, wherein like reference numerals designate identical or corresponding parts throughout the several views:

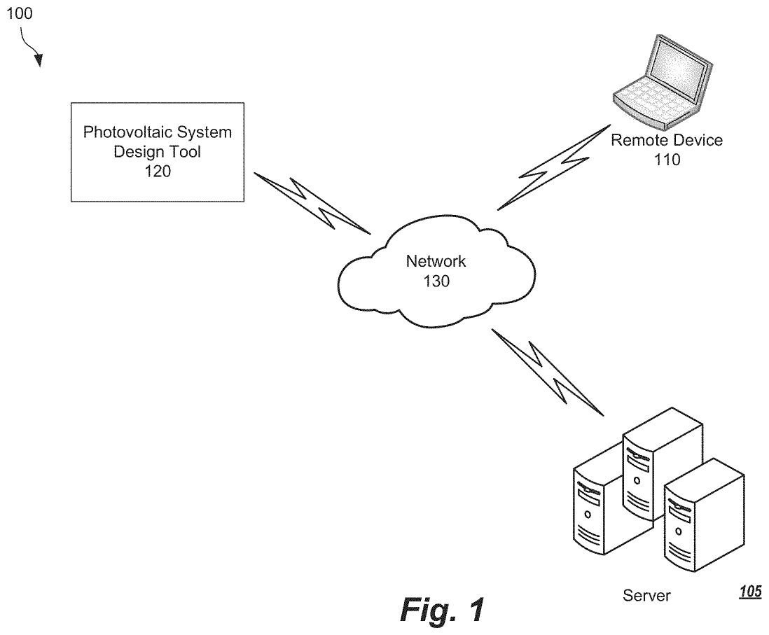

FIG. 1 illustrates an exemplary system 100 for photovoltaic (PV) system design and proposal (herein referred to as the system 100) according to one or more aspects of the disclosed subject matter. It should be appreciated that PV system/panel and solar system/panel may be used interchangeably. The system 100 can include a server 105, a remote device 110, a photovoltaic (PV) system design tool 120, and a network 130.

The server 105 can represent one or more servers communicably coupled to the remote device 110 and the PV system design tool 120 via the network 130. The server 105 can be configured to perform various processing for the system 100 as further described herein. Additionally, the server 105 can represent a dedicated bank of servers, cloud-based processing, and/or a serverless computing system corresponding to a virtualized set of hardware resources.

The remote device 110 can represent one or more remote devices communicably coupled to the server 105 and the PV system design tool 120 via the network 130. The remote device 110 can be a computer, laptop, smartphone, tablet, PDA, and the like. The remote device 110 can be operated by a user to interact with the system 100 as further described herein. For example, a salesperson, a dealer, a client, or a current and/or future customer can use the remote device 110 to connect to the system 100 to generate a PV system design and proposal as further described herein.

The PV system design tool 120 can correspond to the photovoltaic system design tool configured to automatically generate a solar design in real time based on received user input as described in U.S. Pat. No. 10,745,999, which is incorporated herein by reference in its entirety. For example, the server 105 and the remote device 110 can receive information from and transmit information to the PV system design tool 120. Additionally, in one aspect, the PV system design tool 120 can be a portion of a software application executed on the remote device 110 where the software application can also include performing a real-time savings estimates, dynamically changing the design in real-time, updating energy production based on the changes to the design in real-time, and update energy production based on changes to a site and/or built environment in real time, for example, as further described herein.

The network 130 can be a public network, such as the Internet, or a private network, such as an LAN or WAN network, or any combination thereof and can also include PSTN or ISDN sub-networks. The network 130 can also be wired, such as an Ethernet network, or can be wireless such as a cellular network including EDGE, 3G, 4G, and 5G wireless cellular systems. The wireless network can also be Wi-Fi, Bluetooth, or any other wireless form of communication that is known.

Generally, the system 100 can use the PV system design tool 120 to deliver a maximum solar panel design corresponding to a predetermined layout of a maximum number of panels that can be placed on a roof in seconds and allows users to change elements of their site for a solar system design in lieu of requesting a maximum solar panel design from a human design team, for example, which may take upwards of two hours and limits user ability to make fundamental changes to the customer maximum solar panel design and home site. In one aspect, the maximum solar panel design can be SunPower's MaxFit design as described in U.S. Pat. No. 10,902,159, which is incorporated herein by reference in its entirety.

More specifically, the system 110 can use the PV system design tool 120 to “automatically” generate a solar design in real time based on the received user input. “Automatically” is used herein to emphasize features of this disclosure, where conventional computer-implemented tasks that previously relied on substantial user input, direction and manipulation (collectively, “user decisions”), by virtue of the teachings of this disclosure, can be decided and implemented by processing circuitry. This significant improvement in speed and efficiency allows multiple designs to be generated in a single day. Because the solar designs can be generated so quickly, updates and modifications to the designs can be made at any time during the design process without derailing the design process.

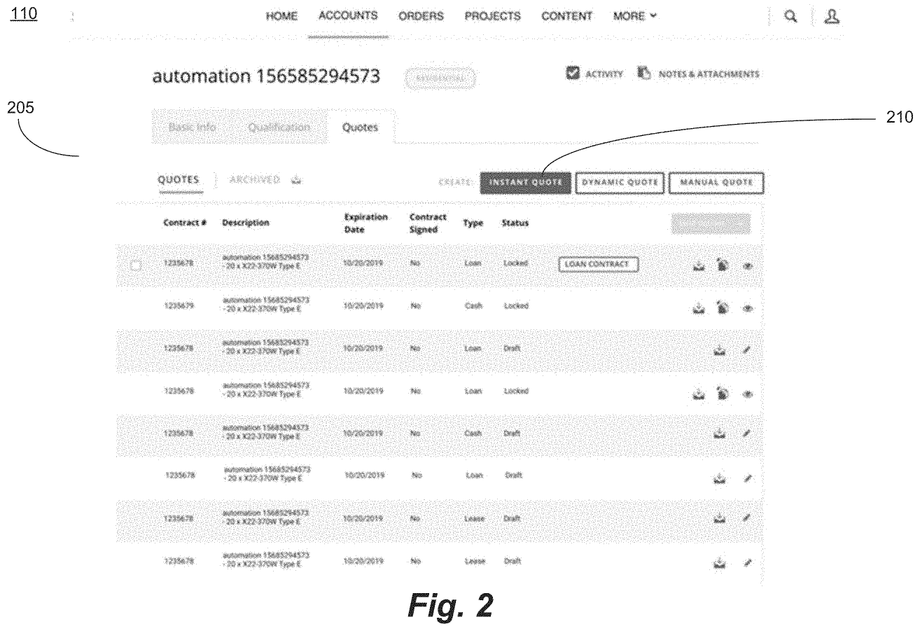

FIG. 2 illustrates an exemplary user interface 205 displayed via the remote device 110 according to one or more aspects of the disclosed subject matter. The user interface 205 includes a button 210 configured to trigger a process of generating a solar design and savings estimate in seconds in response to a user interacting with the button 210. Additionally, after updating and selecting their design, users can generate a final proposal document and agreement.

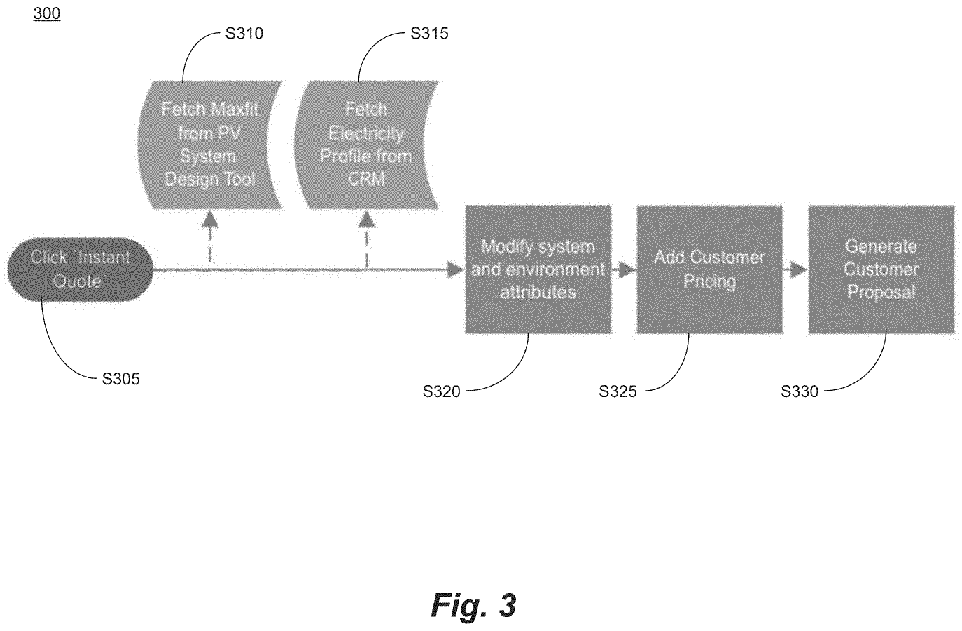

FIG. 3 illustrates an exemplary workflow 300 for generating a customer proposal according to one or more aspects of the disclosed subject matter.

In S305, a user can interact with a button (e.g., the button 210) of the user interface 205 to trigger a process of generating a solar design and savings estimate.

In S310, the system 100 can fetch a maximum solar panel design from the PV system design tool 120. For example, the PV system design tool 120 can be SunPower's Instant Design as further described in U.S. Pat. No. 10,745,999, which is incorporated herein by reference in its entirety.

In S315, the system 100 can fetch an electricity profile from a customer relationship management platform. For example, the system 100 aggregates all customers within the given zip code of the customer's home to determine the most popular utility tariff to model savings after. The monthly average electricity bill provided by the user is then extrapolated into annual savings based on actual electricity costs for that site.

In S320, the system 100 can modify system and environment attributes. For example, the system 100 considers height data for the customer's home site, which includes environmental attributes such as neighboring structures (e.g., buildings, houses, telephone poles, etc.) and flora (e.g., trees). This data could impact the solar access that is estimated for the generated solar design.

In S325, the system 100 can add customer pricing. For example, the user can input their desired sales commission or system price in order to achieve desired customer pricing inclusive of state and local solar incentives for presentation. These purchase options can include Cash, Lease and Loan side-by-side for selection.

In S330, the system 100 can generate a customer proposal. For example, once the user has completed the solar design and added their desired sales commission or system price for product pricing, the user can then generate a customer specific solar proposal which highlights various aspects of the solar value proposition including system design, system components, estimated savings/return, and purchase options. After generating the customer proposal in S330, the process can end.

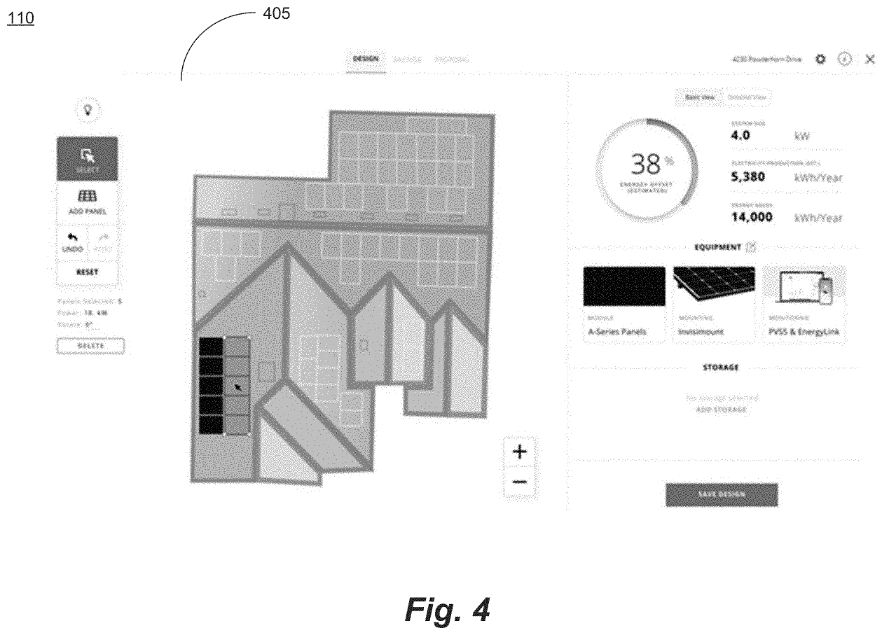

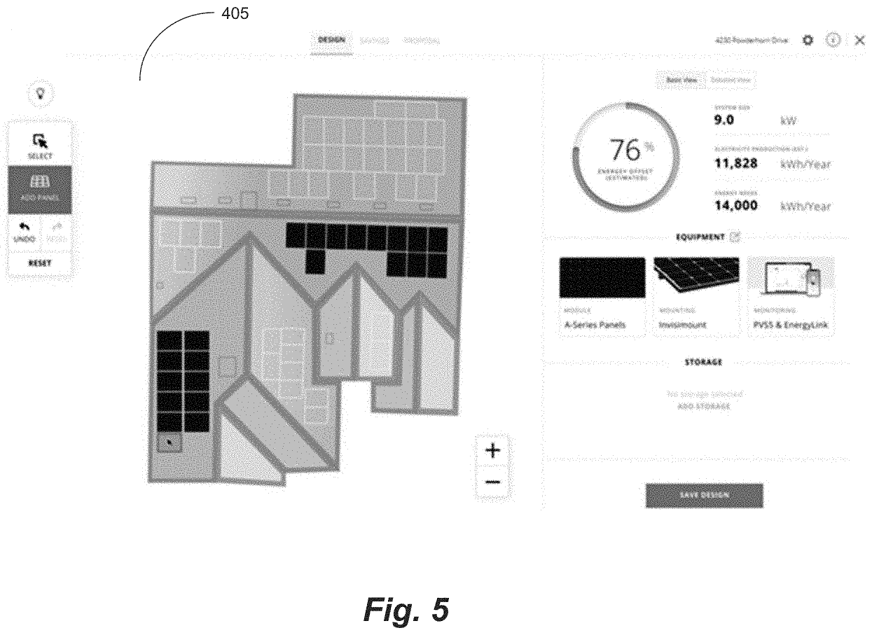

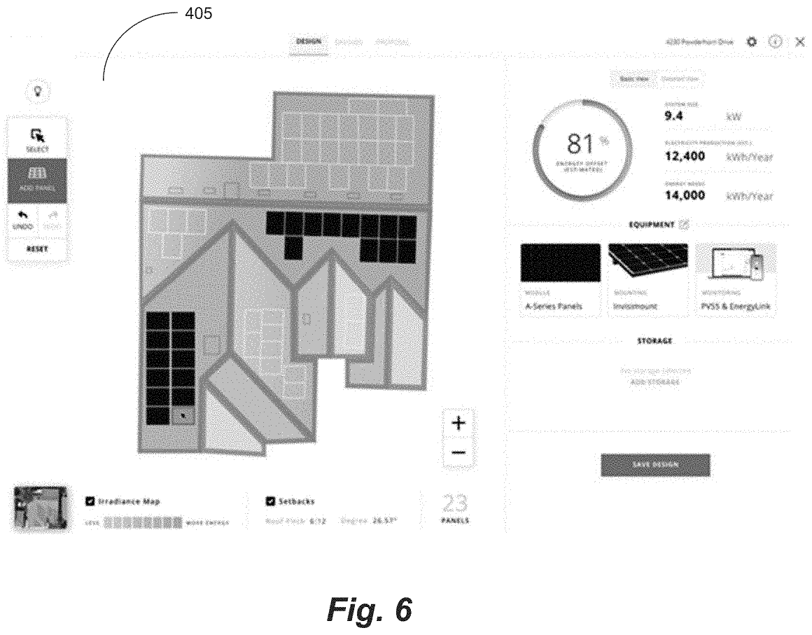

FIG. 4, FIG. 5, and FIG. 6 illustrate an exemplary user interface 405 for creating a construction-ready design according to one or more aspects of the disclosed subject matter. For example, the user interface 405 can be displayed via the remote device 110. The system 100 can be configured to update the design in real time. For example, from a user's perspective, the user can add and remove a solar panel or panels within an existing panel layout grid as illustrated in FIG. 4. Additionally, a user can mirror and snap a solar panel or panels placed. In other words, adding a new module (e.g., PV panel) will ‘snap’ to an existing array and mirror its orientation to an existing set of panels in the array on a roof plane. In one or more aspects of the disclose subject matter, ‘snap’ can refer to an effect where the panel automatically attaches itself to an existing PV panel array. For example, the attaching can occur in response to a user dragging the PV panel within a predetermined distance of the array. As illustrated in FIG. 5, a user can also place or move modules within setback areas of the roof based on local jurisdiction requirements. As illustrated in FIG. 6, the user interface 405 can show site setbacks defined and referenced from the user's Authority Having Jurisdiction (AHJ) (e.g., local jurisdiction) to ensure that PV system designs are compliant with local requirements and meet the customer's energy needs based on obtained electricity usage. Further, the user interface 405 can be configured to only allow users to move and place modules within dedicated areas on a roof plane. Validation will throw if a user tries to place a module outside of the dedicated area.

Additionally, the system 100 can update changes in energy data in real time. In other words, as a user modifies panel location, the displayed energy data can change in real time in response. For example, the roof plane has defined solar insolation and shade (e.g., solar access) for every point on the roof. By changing a panel location, a new solar insolation value for the panel is calculated based on the panel's new area location. Then, energy production values and all downstream calculations are re-calculated. Design edits that result in updating the energy data include adding or removing panels, moving panels, rotating panels, and the like.

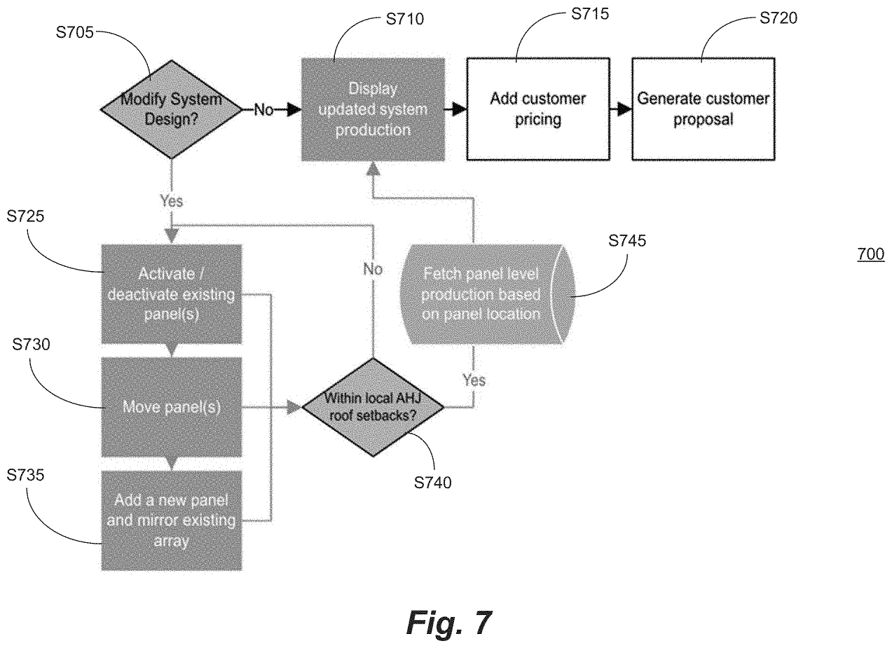

FIG. 7 illustrates an exemplary workflow 700 for modifying the PV system design and displaying real time updates to energy production based on panel movement according to one or more aspects of the disclosed subject matter. In one aspect, the workflow 700 can correspond to S320 in FIG. 3.

In S705, the system 100 can determine if the PV system design is modified. For example, the PV system design can be modified as described in FIGS. 4, 5, and 6. In response to a determination that the PV system design has not been modified, updated PV system production information can be displayed in S710. For example, the PV system production includes energy production of the PV system.

In S715, the system 100 can add customer pricing.

In S720, the system 100 can generate a customer proposal.

However, in response to a determination in S705 that the PV system design has been modified, the system 100 can receive activation and/or deactivation of one or more existing solar panels in S725. For example, a user can interact with the user interface 405 to activate and/or deactivate one or more existing solar panels in the design (e.g., by clicking/tapping on the solar panel).

In S730, the system 100 can receive movement of one or more solar panels. For example, a user can interact with the user interface 405 to move one or more solar panels (e.g., click and hold to drag the solar panel to a different location).

In S735, the system 100 can be configured to add a new panel based on user input and mirror an existing array.

It should be appreciated that for each of S725, S730, and S735, one or more of these steps can be performed and it is not required that they all be performed.

In S740, it can be determined for each of S725, S730, and S735 that did occur whether the design modification falls within local AHJ roof setbacks. In response to a determination that the design modification is not within the local AHJ roof setbacks, the process can return to S725, S730, and/or S735 to receive another design modification to determine if that design modification is within the local AHJ roof setback. However, in response to a determination that the design modification is within the local AHJ roof setbacks, the system 100 can fetch panel (e.g., solar panel) level production for each panel based on panel location (e.g., one or more of geographical location of the panel and a location and orientation of the panel on the roof) in S745. The AHJ information for the design is being fetched from an AHJ database stored in the customer relationship management platform. After fetching panel level production based on panel location in S745, the process can continue to S710 to display updated PV system production.

After the customer proposal is generated in S720, the process can end.

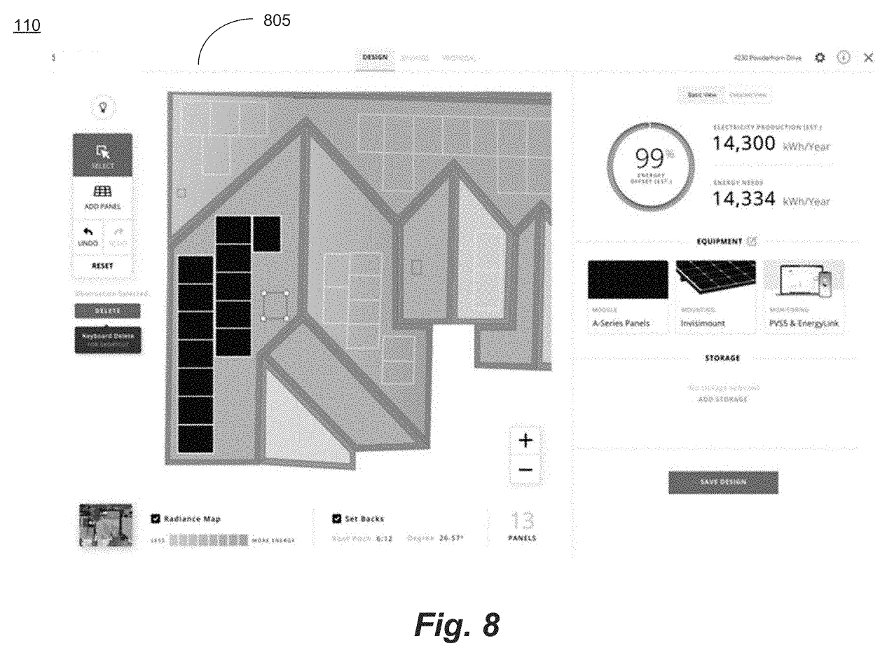

FIG. 8 illustrates an exemplary user interface 805 for modifying a built environment and displaying energy production corresponding to the built environment according to one or more aspects of the disclosed subject matter. The built environment is defined as including digital surface model (DSM) data, AHJ specifications, module placement, and obstruction detection which presents the customer with a proposed system design. For example, the user interface 805 can be displayed via the remote device 110. To modify a built environment and display energy production corresponding to the built environment, a 3D shade model can be kept in memory. When the built environment is changed (e.g., user interaction with the user interface 805), the 3D model changes. As a result, insolation and/or shading values are recalculated, which affects all downstream calculations as well. Design edits that result in updating the built environment can include removing, adding, or changing a shape of a roof obstruction, moving a roof obstruction, removing, adding, or changing a shape of one or more trees, and adjusting roof size and/or dimensions.

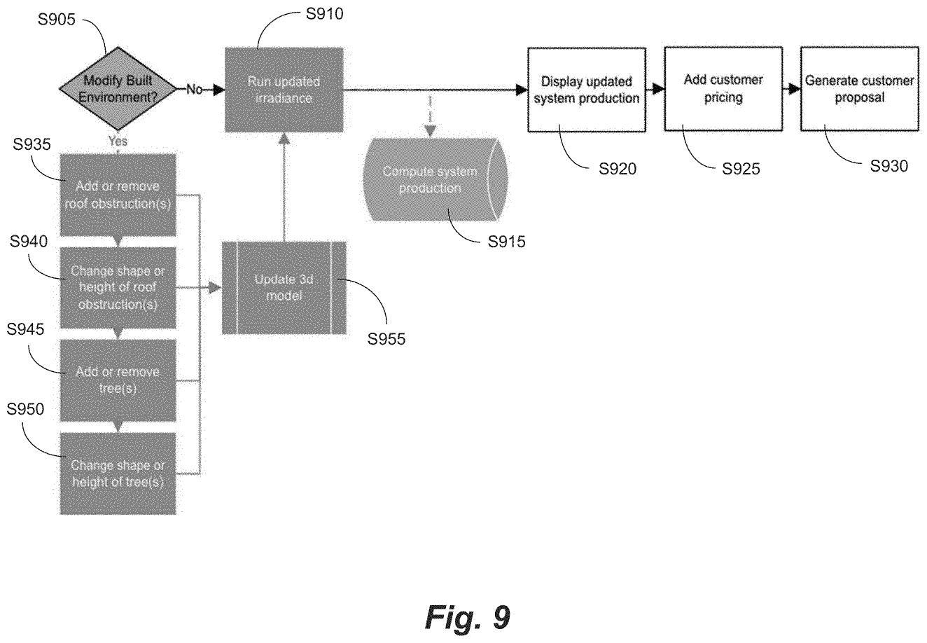

FIG. 9 illustrates a workflow 900 for modifying a built environment and displaying energy production corresponding to the built environment according to one or more aspects of the disclosed subject matter.

In S905, the system 100 can determine if the built environment is modified. For example, the built environment can be modified as described in FIG. 8. In response to a determination that the built environment has not been modified, the system 100 can run updated irradiance in S910. In other words, irradiance can be modified by the addition or removal of roof obstructions such as vertical vents or chimneys. Once these obstructions are added or removed, the model is updated and irradiance is run again to updated irradiance based on changes made.

In S915, the system 100 can compute system production (e.g., energy production corresponding to system production of the PV system in the built environment).

In S920, the system 100 can display updated system production. For example, the updated system production can be displayed by the user interface 805.

In S925, the system 100 can add customer pricing.

In S930, the system 100 can generate a customer proposal. In one aspect, the customer proposal includes marketing material, the financial product/cost value proposition, and solar system specifications.

However, in response to a determination that the built environment has been modified, the system 100 can receive user input to add or remove one or more roof obstructions in the built PV system environment in S935. For example, in one or more aspects of the disclose subject matter, user input can refer to a user clicking with a mouse and/or tapping on a tablet or smartphone with their finger.

In S940, the system 100 can receive user input to change a shape and/or height of roof obstructions in the built PV system environment.

In S945, the system 100 can receive user input to add or remove one or more trees in the built PV system environment. For example, trees within a predetermined distance of the PV system can block some portion of sunlight from reaching one or more PV panels in the PV system.

In S950, the system 100 can receive user input to change a shape and/or height of one or more trees in the built PV system environment.

It should be appreciated that for each of S935, S940, S945, and S950, one or more of these steps can be performed and it is not required that they all be performed.

In S955, the system 100 can update a 3D model of the built PV system environment based on any changes received from S935-S950. After updating the 3D model, the process can return to S910 to run updated irradiance.

After the customer proposal is generated in S930, the process can end.

The system 100 includes many advantages. For example, the system 100 solves the delay in providing homeowners with an accurate, customer designed solar system with a supporting value proposition. The value is that homeowners can quickly qualify themselves and their home for solar energy in the matter of minutes, which is something that traditionally takes hours.

In the above description of FIGS. 3, 7, and 9, any processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The various elements, features, and processes described herein may be used independently of one another, or may be combined in various ways. All possible combinations and sub-combinations are intended to fall within the scope of this disclosure.

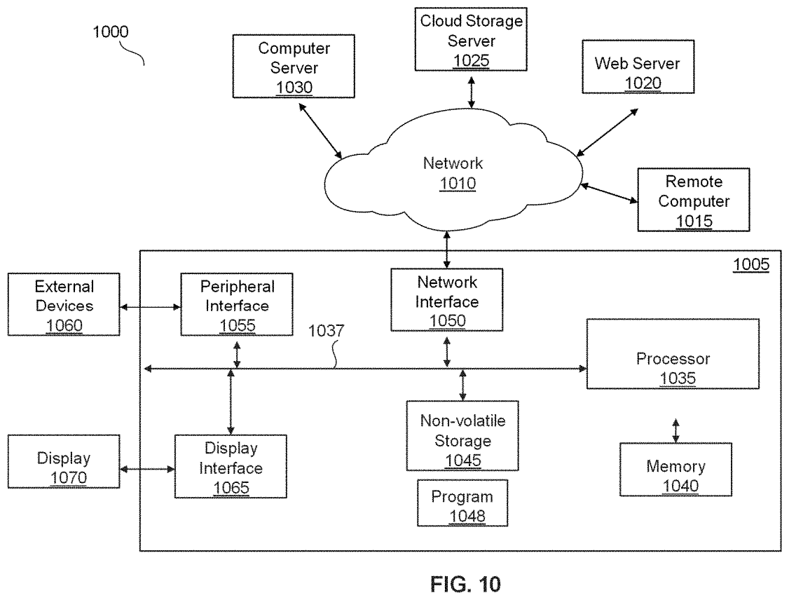

FIG. 10 illustrates a block diagram of a computer that may implement the various embodiments described herein.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or compute server, or any combination of these computing devices. The remote computer or compute server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 10 is a functional block diagram illustrating a networked system 1000 of one or more networked computers and servers. In an embodiment, the hardware and software environment illustrated in FIG. 10 may provide an exemplary platform for implementation of the software and/or methods according to the present disclosure.

Referring to FIG. 10, a networked system 1000 may include, but is not limited to, computer 1005, network 1010, remote computer 1015, web server 1020, cloud storage server 1025 and compute server 1030. In some embodiments, multiple instances of one or more of the functional blocks illustrated in FIG. 10 may be employed.

Additional detail of computer 1005 is shown in FIG. 10. The functional blocks illustrated within computer 1005 are provided only to establish exemplary functionality and are not intended to be exhaustive. And while details are not provided for remote computer 1015, web server 1020, cloud storage server 1025 and compute server 1030, these other computers and devices may include similar functionality to that shown for computer 1005.

Computer 1005 may be a personal computer (PC), a desktop computer, laptop computer, tablet computer, netbook computer, a personal digital assistant (PDA), a smart phone, or any other programmable electronic device capable of communicating with other devices on network 1010. In one aspect, the computer 1005 may correspond to the remote device 110.

Computer 1005 may include processor 1035, bus 1037, memory 1040, non-volatile storage 1045, network interface 1050, peripheral interface 1055 and display interface 1065. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 1035 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 1037 may be a proprietary or industry standard high-speed parallel or serial peripheral interconnect bus, such as ISA, PCI, PCI Express (PCI-e), AGP, and the like.

Memory 1040 and non-volatile storage 1045 may be computer-readable storage media. Memory 1040 may include any suitable volatile storage devices such as Dynamic Random Access Memory (DRAM) and Static Random Access Memory (SRAM). Non-volatile storage 1045 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 1048 may be a collection of machine readable instructions and/or data that is stored in non-volatile storage 1045 and is used to create, manage and control certain software functions that are discussed in detail elsewhere in the present disclosure and illustrated in the drawings. In some embodiments, memory 1040 may be considerably faster than non-volatile storage 1045. In such embodiments, program 1048 may be transferred from non-volatile storage 1045 to memory 1040 prior to execution by processor 1035.

Computer 1005 may be capable of communicating and interacting with other computers via network 1010 through network interface 1050. Network 1010 may be, for example, a local area network (LAN), a wide area network (WAN) such as the Internet, or a combination of the two, and may include wired, wireless, or fiber optic connections. In general, network 1010 can be any combination of connections and protocols that support communications between two or more computers and related devices.

Peripheral interface 1055 may allow for input and output of data with other devices that may be connected locally with computer 1005. For example, peripheral interface 1055 may provide a connection to external devices 1060. External devices 1060 may include devices such as a keyboard, a mouse, a keypad, a touch screen, and/or other suitable input devices. External devices 1060 may also include portable computer-readable storage media such as, for example, thumb drives, portable optical or magnetic disks, and memory cards. Software and data used to practice embodiments of the present disclosure, for example, program 1048, may be stored on such portable computer-readable storage media. In such embodiments, software may be loaded onto non-volatile storage 1045 or, alternatively, directly into memory 1040 via peripheral interface 1055. Peripheral interface 1055 may use an industry standard connection, such as RS-232 or Universal Serial Bus (USB), to connect with external devices 1060.

Display interface 1065 may connect computer 1005 to display 1070. Display 1070 may be used, in some embodiments, to present a command line or graphical user interface to a user of computer 1005. Display interface 1065 may connect to display 1070 using one or more proprietary or industry standard connections, such as VGA, DVI, DisplayPort and HDMI.

As described above, network interface 1050, provides for communications with other computing and storage systems or devices external to computer 1005. Software programs and data discussed herein may be downloaded from, for example, remote computer 1015, web server 1020, cloud storage server 1025 and compute server 1030 to non-volatile storage 1045 through network interface 1050 and network 1010. Furthermore, the systems and methods described in this disclosure may be executed by one or more computers connected to computer 1005 through network interface 1050 and network 1010. For example, in some embodiments the systems and methods described in this disclosure may be executed by remote computer 1015, computer server 1030, or a combination of the interconnected computers on network 1010.

Data, datasets and/or databases employed in embodiments of the systems and methods described in this disclosure may be stored and or downloaded from remote computer 1015, web server 1020, cloud storage server 1025 and compute server 1030.

Obviously, numerous modifications and variations of the present disclosure are possible in light of the above teachings. It is therefore to be understood that within the scope of the appended claims, the disclosure may be practiced otherwise than as specifically described herein.

Having now described embodiments of the disclosed subject matter, it should be apparent to those skilled in the art that the foregoing is merely illustrative and not limiting, having been presented by way of example only. Thus, although particular configurations have been discussed herein, other configurations can also be employed. Numerous modifications and other embodiments (e.g., combinations, rearrangements, etc.) are enabled by the present disclosure and are within the scope of one of ordinary skill in the art and are contemplated as falling within the scope of the disclosed subject matter and any equivalents thereto. Features of the disclosed embodiments can be combined, rearranged, omitted, etc., within the scope of the invention to produce additional embodiments. Furthermore, certain features may sometimes be used to advantage without a corresponding use of other features.

Accordingly, Applicant(s) intend(s) to embrace all such alternatives, modifications, equivalents, and variations that are within the spirit and scope of the disclosed subject matter.

1. A method, comprising:
fetching a maximum solar panel design for a photovoltaic (PV) system design from a photovoltaic system design tool;
fetching an electricity profile for the photovoltaic system design;
receiving one or more modifications to one or more of the photovoltaic system design and an environment of a photovoltaic system;
determining customer pricing based on one or more of the modified photovoltaic system design and the modified environment of the photovoltaic system; and
generating a customer proposal based on the modified photovoltaic system design and the modified environment of the photovoltaic system.

2. The method of claim 1, wherein receiving one or more modifications to one or more of the photovoltaic system design and an environment of the photovoltaic system includes
activating PV panels that already exist in the PV system design.

3. The method of claim 1, wherein receiving one or more modifications to one or more of the photovoltaic system design and an environment of the photovoltaic system includes
deactivating PV panels that already exist in the PV system design.

4. The method of claim 1, wherein receiving one or more modifications to one or more of the photovoltaic system design and an environment of the photovoltaic system includes
moving one or more PV panel to a different location on a roof corresponding to the PV system design.

5. The method of claim 1, wherein receiving one or more modifications to one or more of the photovoltaic system design and an environment of the photovoltaic system includes
adding a new PV panel to the PV system design.

6. The method of claim 5, wherein adding a new PV panel to the PV system design includes
automatically adding the PV panel to an existing PV panel array and mirroring an orientation of the added PV panel to a set of panels in the existing array on a roof plane.

7. The method of claim 1, further comprising:
in response to receiving one or more modifications to one or more of the photovoltaic system design and an environment of the photovoltaic system, determining whether the one or more modifications is within local roof setbacks.

8. The method of claim 7, further comprising:
in response to a determination that the one or more modifications is within local roof setbacks, fetching PV panel level production for each PV panel based on a location of the PV panel on a roof.

9. The method of claim 1, further comprising:
displaying energy production of the PV system.

10. The method of claim 1, further comprising:
modifying a built PV system environment.

11. The method of claim 10, further comprising:
adding or removing one or more roof obstructions in the built PV system environment.

12. The method of claim 10, further comprising:
changing one or more of a shape and height of one or more roof obstructions.

13. The method of claim 10, further comprising:
adding or removing one or more trees in the built PV system environment.

14. The method of claim 13, further comprising:
changing one or more of a shape and height of one or more trees in the built PV system environment.

15. The method of claim 10, further comprising:
in response to modifying the built PV system environment, update a three-dimensional model of the built PV system environment.

16. The method of claim 15, further comprising:
updating an irradiance of the PV system design.

17. One or more computer readable medium including computer program instructions, which when executed by an information processing system, cause the system to:
fetch a maximum solar panel design for a photovoltaic (PV) system design from a photovoltaic system design tool;
fetch an electricity profile for the photovoltaic system design;
receive one or more modifications to one or more of the photovoltaic system design and an environment of a photovoltaic system;
determine customer pricing based on one or more of the modified photovoltaic system design and the modified environment of the photovoltaic system; and
generate a customer proposal based on the modified photovoltaic system design and the modified environment of the photovoltaic system.

18. The one or more computer readable medium of claim 17, wherein the information processing system is a server.

19. The one or more computer readable medium of claim 17, wherein the information processing system is a cloud-based architecture.

20. A server, comprising:
processing circuitry configured to
fetch a maximum solar panel design for a photovoltaic (PV) system design from a photovoltaic system design tool;
fetch an electricity profile for the photovoltaic system design;
receive one or more modifications to one or more of the photovoltaic system design and an environment of a photovoltaic system;
determine customer pricing based on one or more of the modified photovoltaic system design and the modified environment of the photovoltaic system; and
generate a customer proposal based on the modified photovoltaic system design and the modified environment of the photovoltaic system.
